(19) United States
(12) Patent Application Publication
(10) Pub. No.: US 2012/0188620 A1
(43) Pub. Date: Jul. 26, 2012

(54) Laser image projection system applicable to the marking of objects and method for generating holograms

(75) Inventors: Sebastian Rodrigo De Echaniz, Sant Quirze Del Valles (ES); Ramon Sans Ravellat, Sant Quirze Del Valles (ES)

(73) Assignee: Easy Laser, S.L., Sant Quirze Del Valles (ES)

(21) Appl. No.: 13/377,781

(22) PCT Filed: Jun. 9, 2010
(86) PCT No.: PCT/EP10/58105

§ 371 Date: Dec. 12, 2011

(30) Foreign Application Priority Data
Jun. 10, 2009 (ES) ES 200930291

(51) Int. Cl. G03H 1/08; G03B 21/16; G03B 21/26

(52) U.S. Cl. 359/9; 353/28; 353/52; 353/121

(57) ABSTRACT

Laser image projection system applicable to the marking of objects and method for generating holograms may include a reflection spatial light modulator, laser beam irradiating means for irradiating laser light onto the reflection spatial light modulator at a certain incidence angle, controlling means connected to the reflection spatial light modulator, the controlling means controlling said reflection spatial light modulator to define a holographic diffraction pattern corresponding to the desired optical image intended to be irradiated onto the object, and focusing means for performing a Fourier transform of the phase-modulated laser light to transform it into the optical image and irradiate it focused onto said object, wherein said focusing means includes a Fresnel lens holographically defined onto the reflection spatial light modulator to thereby improve an efficiency in the use of the light energy irradiated by said irradiating means.

### TECHNICAL FIELD

The present invention relates in general, in a first aspect, to a laser image projection system applicable to the marking of objects equipped with a reflection spatial light modulator, or SLM, and particularly relates to a system with focusing means comprising a Fresnel lens holographically defined onto said reflection spatial light modulator SLM.

A second aspect of the invention relates to a method for generating holograms to be applied onto an SLM of a laser image projection system applicable to the marking of objects, and particularly relates to a method that comprises performing an image pixel equalization from which to calculate one of said holograms.

Both the system and the method proposed by the invention improve the efficiency in the use of the irradiated laser light energy.

### PRIOR ART

Some laser image projection systems used for different purposes, particularly for the marking of objects, are known.

Such systems, or laser systems for marking by electronically generating a mask pattern, comprise a system of physical lenses through which a laser beam is transmitted, which expands before hitting a spatial light modulator, or SLM. The SLM modulates the phase of the reflected beam that projects onto a surface where the projection or marking image is created. The modulation of the laser is controlled in real-time by a computer by means of the SLM controller.

The SLM is a spatial light modulator composed of a matrix of liquid crystal cells that are able to modulate the incident light phase. In this sense, these cells form an array of active holographic diffraction that acts on the laser. The emerging light is then transformed conventionally by a physical lens with a specific focal length to form the image. The lens in this case acts as a Fourier transform:

h(x,y)=F[h( x̅, y̅)],

where h( x̅, y̅) represents the beam modulated by the hologram of the SLM, H (x, y) is the image formed, and F represents the Fourier transform.

In the patent U.S. Pat. No. 6,710,292B2 one of these systems is described comprising:
an SLM;
laser beam irradiating means for irradiating “readout” laser light onto said SLM at a certain incidence angle;
writing means provided to define a holographic diffraction pattern onto the SLM corresponding to the desired optical image and intended to be irradiated onto an object, by means of the modulated reflection of the phase of said laser light irradiated according to said diffraction pattern; and
a Fourier lens for performing a Fourier transform of said phase-modulated laser light to transform it into said optical image and to irradiate it.

In patent EP0840159B1 a system is proposed analogous to that proposed in U.S. Pat. No. 6,710,292, but of greater complexity, particularly with reference to the filtering optical system that includes, in addition to a Fourier lens, an inverse Fourier lens as well as other additional optical elements.

In both U.S. Pat. No. 6,710,292 and EP0840159B1, the lenses included in the systems therein proposed are physical lenses that are external to the SLM. The utilization of such physical lenses generates several problems ranging from technical problems relating to those caused by the very dimensions of said lenses and their assembly in such systems, to the commonly known zero-order effect that occurs when part of the laser light that is irradiated, but not modulated, onto the SLM is reflected by the latter and subsequently focused by the Fourier physical lens onto the projection focal plane of the image, thus producing a point of unwanted high intensity.

In order to solve this zero-order effect in the cited patents external elements are included previously and/or subsequently to the reflection of the laser light onto the SLM, which either shift the phase of the zero-order light component (EP0840159B1), or cancel it by means of the interposition of a mask after its reflection onto the SLM (U.S. Pat. No. 6,710,292).

In any case, the incorporation of such external elements into the SLM only increases the system volume and the number of optical elements through which the laser beam must pass which can reduce the total energy efficiency of the latter, as well as requiring greater adjustment of all said optical elements to prevent discrepancies in the image finally projected with respect to the desired image. At the same time, the incorporation of such elements involves the consequent increase in cost of the system.

Said reduction in the light energy finally projected in relation to that irradiated means that the latter must be enlarged proportionally to the number of optical elements incorporated into the system in order for the projected image to have the adequate energy level for the specific application, for example in the case of application for the marking of objects, it must be sufficient to produce said mark.

The present inventors do not know of laser image projection systems that are applicable to the marking of objects that include lenses other than physical lenses external to the SLM.

On the other hand, a drawback of the conventional generation of the holograms to be defined onto the SLMs of said systems is that said generation fails to make efficient use of the irradiated light energy, since the points of the resulting projected image do not have homogeneous energy distribution, neither in one image or among different images, which in the case of marking images projected onto an object causes some points/images to be marked with greater intensity than others.

The present inventors do not know of proposals relating to methods for generating holograms to be applied onto an SLM of a laser image projection system applicable to the marking of objects that improve efficiency in the use of irradiated light energy.

### DISCLOSURE OF THE INVENTION

It appears necessary to offer an alternative to the state of the art that makes laser projection of images possible by means of a system equipped with an SLM that improves efficiency in the use of irradiated laser light energy.

To this end, the present invention refers, in a first aspect, to a laser image projection system for the marking of objects, conventionally comprising:
a reflection spatial light modulator, or SLM;
laser beam irradiating means for irradiating laser light onto said reflection spatial light modulator SLM at a certain incidence angle;
controlling means connected to said SLM and intended to control it so that it defines a holographic diffraction pattern (known as CGH) corresponding to the desired optical image and intended to be irradiated onto an object, by means of the modulated reflection of the phase of said laser light irradiated according to said diffraction pattern; and
focusing means to perform a Fourier transform of said phase-modulated laser light in order to transform it into said optical image and to irradiate it focused onto said object.

Unlike conventional systems, in that proposed by the present invention, the focusing means comprise a Fresnel lens holographically defined onto the SLM in order to improve efficiency in the use of the light energy irradiated by said irradiating means in comparison with the conventional systems, the focusing means of which comprise one or more physical lenses to perform said Fourier transform thus causing a decrease in the light energy passing through them. Said Fresnel lens can be parameterized at will and in real-time by said control means.

According to an embodiment example, said focusing means only comprise said Fresnel lens, which is configured by said control means, in order to perform said Fourier transform, while according to another alternative embodiment example, the focusing means also comprise an optical system formed by one or more physical lenses intended to perform said Fourier transform in cooperation with said Fresnel lens, in this case causing the physical lens or lenses used to lose less energy than those in the conventional systems performing the entire Fourier transform.

In addition to improving efficiency in the use of light energy, according to some embodiment examples of the system proposed by the present invention, the holographic Fresnel lens mentioned is configured to cancel the possible effect of a zero-order focus that part of said irradiated laser light could cause upon being reflected by the reflection spatial light modulator SLM.

By removing masks and/or physical lenses that are utilized in the conventional systems to cancel the zero-order effect, efficiency in the use of light energy is improved since these elements are responsible for some energy losses that the system proposed by the present invention does not produce.

Another advantage of the holographic Fresnel lens included in the system proposed by the invention is the capacity to vary its focal length by calculating it together with the CGH. In this way it can be focused on different planes without the need to adjust a physical lens (or series of lenses) manually.

In the case in which the focusing means only comprise the holographic Fresnel lens, the latter is configured not to focus said zero-order focus but rather to focus said optical image properly onto said object.

Alternatively, in the case in which the Fourier transform is performed by the combination of the Fresnel lens and the optical system mentioned, the Fresnel lens is configured to shift the focal plane of the modulated laser light with respect to the unmodulated laser light or zero-order one, so that the latter appears out of focus on said object and without sufficient energy to produce a mark when the system is applied to the marking of objects.

In said case in which the system is applied to the marking of objects, the system is intended to carry out the marking of said object by means of at least one single laser pulse.

Efficiency in the use of the irradiated laser light energy is also affected by the warming of the SLM. In order to produce a mark with a single pulse, the average power of the laser should be high, which will warm the active surface of the SLM liquid crystal, or even damage it. When the liquid crystal warms, the modulation of the laser phase is affected and therefore the marking image is damaged.

In order to solve this drawback, the system proposed by the first aspect of the invention comprises thermal conditioning means that are arranged in the SLM in order to regulate the temperature of the latter and thus to overcome the reduction in the above-mentioned light efficiency due to the warming of the SLM.

Although the marking of objects is a preferred embodiment of the system proposed by the invention, it is not limited to this application and can be used in any application that requires laser projection of images onto an object, such as the one that creates a series of visual effects by projecting said images onto a screen.

In order to create the desired image on the focal plane it is necessary to calculate the hologram, known as CGH, that once transformed will build the image. This calculation is performed by means of an iterative Fourier transform algorithm, or IFTA, such as the Gerchberg-Saxton algorithm.

A second aspect of the invention concerns a method for generating holograms to be applied onto an SLM of a laser image projection system applicable to the marking of objects comprising, by means of known method, the application of an iterative Fourier transform algorithm, or IFTA, onto the pixels of one image, in order to estimate a CGH hologram or holographic diffraction pattern to be defined in said reflection spatial light modulator SLM.

A drawback with the IFTAs is that in the resulting image the energy at each one of its points is not homogeneous and the result also depends on the number of points to be projected, thus the conventional utilization of these algorithms is not as efficient in terms of use of irradiated light energy.

Unlike the conventional methods, that proposed by the second aspect of the invention comprises the execution of a step prior to the application of said algorithm, consisting in the equalization of the pixels of said image in order to homogenize the light energy of the points of the projected image with the aim of improving efficiency in the use of light energy irradiated onto said SLM.

The IFTAs are a type of very computationally-intensive algorithms as they require the calculation of several Fourier transforms of extensive matrices. In order to reduce the calculation time and thus to be able to update the CGH with greater frequency, the method comprises, for one embodiment example, applying said algorithm to the pixels of one image of smaller dimensions onto the active surface of said SLM, and further comprises carrying out a step subsequent to the application of said algorithm consisting in the repetition of the image or hologram obtained, as a result of the application of said algorithm, along the entire active surface of said SLM until covering it completely.

In other words, the method comprises applying the algorithm to a reduced image (128×128 for example), where each pixel represents a point to be projected and then to repeat the obtained CGH several times until filling the entire area of the SLM (800×600 for example). This process is referred to as “tiling” in the present specification. In this way, apart from considerably reducing the calculation time of the CGH, laser concentration onto each one of the points to be projected is made possible, thus making it possible to obtain high energy density per point and to reduce the power or energy demand on the laser, that is to say improving efficiency in the use of the irradiated light energy.

A problem presented by the SLMs is that the projected image is modified by the diffraction due to SLM pixellation, that is to say, the diffraction of a pixel.

In order to overcome this problem the method comprises, subsequent to said equalization step, carrying out a step comprising the diffraction compensation of each pixel.

If the projected image is represented by the following equation:

$$\hat{H} ( x , y ) = H ( x , y ) sin c ( \frac{x}{λ fa} , \frac{y}{λ fb} ) ,$$

where a and b correspond to the size of a pixel in the x and y direction, respectively, A is the wavelength of the laser and f the focal distance of the lens, then the pixellation compensation mentioned is carried out, according to an embodiment example of the proposed method, by multiplying the original image that is to be projected by the inverse of this sinc function (where

$$sin c ( x ) = \frac{sin ( π x )}{π x} ) ,$$

after the equalization and before the IFTA. In this way, once the obtained CGH is transformed, the “sinc” function and its inverse will be cancelled.

According to an embodiment example, the proposed method is applied to the generation of holograms to be applied onto the reflection spatial light modulator SLM of the system proposed according to the first aspect of the invention.

The method proposed by the second aspect of the invention comprises holographically defining the cited Fresnel lens onto the SLM of the system proposed by the first aspect, superimposing the phase of the Fresnel lens onto the final phase of the CGH, or holographic diffraction pattern, defined onto the SLM.

The present invention also contemplates applying a method like that proposed by the second aspect of the invention for calculating images in order to generate holograms onto devices other than an SLM.

### BRIEF DESCRIPTION OF THE DRAWINGS

The previous and other advantages and characteristics will be better understood through the following detailed description of some embodiment examples with reference to the enclosed drawings that should be considered as illustrative and not limitative, wherein:

FIG. 1 schematically shows the system proposed by the first aspect of the invention, according to an embodiment example;

FIG. 2 illustrates a phase of a Fresnel lens holographically defined onto the SLM of the system proposed by the first aspect of the invention, according to an embodiment example;

FIG. 3 is another schematic view of the system proposed by the first aspect of the invention, according to another embodiment example;

FIG. 4 shows the SLM of the system proposed by the invention according to an embodiment example comprising thermal conditioning means arranged on the SLM, and

FIG. 5 schematically illustrates the different steps carried out according to the method proposed by the second aspect of the invention, according to an embodiment example;

### DETAILED DESCRIPTION OF EMBODIMENT EXAMPLES

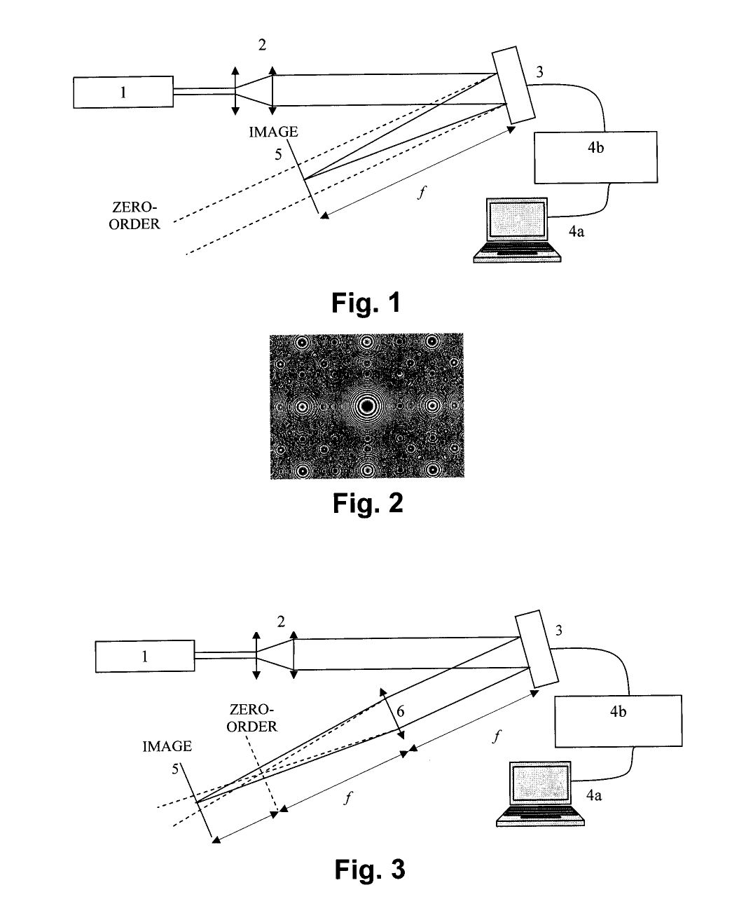

In FIGS. 1 and 3 the system proposed by the first aspect of the invention for both embodiment examples sharing a series of common elements is illustrated, particularly:
an SLM, indicated by the numerical reference 3;
laser beam irradiating means to irradiate laser light onto said SLM 3 at a certain incidence angle, that in this case comprise a laser light source 1 and a beam expander 2;
controlling means, formed in this case by a computerized system 4a and a controller 4b, connected to the SLM and provided to control it in order to define a holographic diffraction pattern or CGH corresponding to the desired optical image and intended to be irradiated onto an object 5, by means of the modulated reflection of the phase of said laser light irradiated according to said diffraction pattern; and
focusing means for performing a Fourier transform of said phase-modulated laser light to transform it into said optical image and to irradiate it focused onto said object 5.

In both cases the computerized system 4a is responsible for calculating both the CGH and the holographic Fresnel lens, for adding them and for sending the result to the controller 4b, so that the latter can apply it onto the SLM.

For certain applications, the calculation rate of the CGH hologram is not quick enough, even when using the most up-to-date computer processors. For this reason, for an embodiment example of the system proposed the control means mentioned comprise a graphics processing unit to calculate the CGH from some pixels of the desired optical image as well as the Fresnel lens.

Said graphics processing unit can be of a different type, such as a graphics card (not illustrated) forming part of the computerized system 4a illustrated in FIGS. 1 and 3, since the graphic card processors (GPU) have several processors that can operate in parallel, or for other embodiment examples, the graphics processing unit consists of any kind of programmable hardware, such as field programmable gate arrays (FPGA) or digital signal processors (DSP), or other electronic or data processing means.

Firstly referring to FIG. 1, this represents the embodiment example wherein the focusing means only comprise a Fresnel lens (not illustrated) holographically defined onto the SLM, whose phase is illustrated as an example in FIG. 2.

For said embodiment example of FIG. 1, the holographic Fresnel lens is configured so that it does not focus the zero-order focus but rather focuses the optical image properly onto the object 5, at a distance f′ from the SLM.

In FIG. 3 the previously described embodiment example is illustrated, wherein the focusing means comprise the holographic Fresnel lens (not illustrated) and an optical system that in this case is formed by one single lens 6 that cooperates with the Fresnel lens to perform the Fourier transform of the laser light phase modulated by the SLM.

According to said embodiment example illustrated in FIG. 3, the zero-order effect is cancelled due to the fact that the Fresnel lens is configured to shift the focal plane of the modulated laser light with respect to the unmodulated or zero-order laser light so that the latter appears out of focus on object 5 and without enough energy density to produce a mark. It can be seen in said FIG. 3 that the focal plane of the zero-order effect (indicated with dashed lines) has advanced a distance z with respect to that of object 5 where the image, generated by the modulated light, is properly focused.

The Fresnel lens is generally calculated by means of the following equation:

$$L = exp ( - i \frac{π}{λ {f}^{′}} ( {\overline{x}}^{2} + {\overline{y}}^{2} ) ) ,$$

where f′ is the focal length of the Fresnel lens. The phase of the Fresnel lens should be added to the phase of the CGH to carry out the following translation:

$$z = - \frac{{f}^{2}}{{f}^{′}}$$

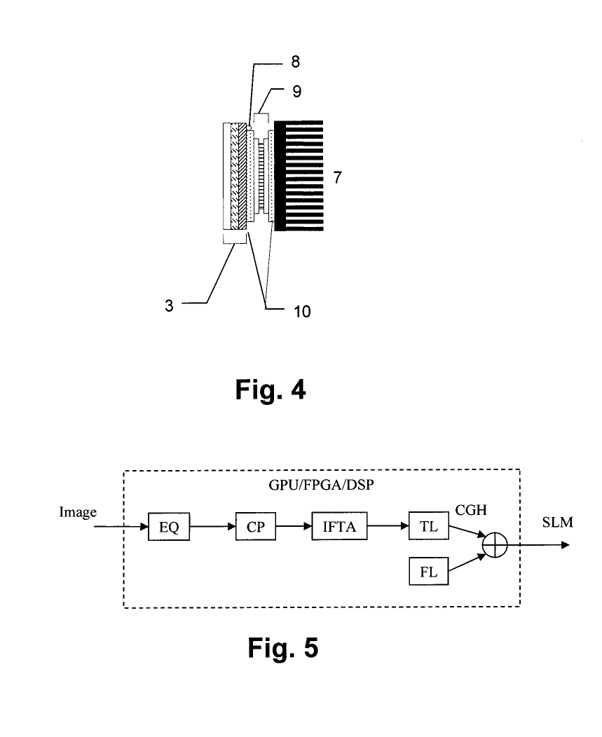

In FIG. 4 an embodiment example is illustrated, wherein the system proposed by the first aspect of the invention comprises thermal conditioning means that are arranged on the SLM in order to regulate the temperature of the same, and thus to overcome the reduction in the above-mentioned light efficiency due to the warming of the SLM.

In particular, the thermal conditioning means comprise a temperature sensor 8 that is in contact with the rear part of the SLM 3 (represented in cross-section in FIG. 4, allowing the three layers forming it to be seen), a thermoelectric cell 9 with a side built against the rear part of the SLM 3, by means of a layer made in a heat conductive material 10, a heat sink 7 built against the free side of said thermoelectric cell 9, also by means of another layer of heat conductive material 10, and a control system (not illustrated) connected to said temperature sensor 8 and to said thermoelectric cell 9 and intended to control it in order to refrigerate or to heat the SLM 3 depending on the temperature variations detected by said temperature sensor 8.

A second aspect of the invention concerns a method that, as has already been described in a previous section, comprises carrying out a step prior to the application of the IFTA algorithm that consists in an equalization of the pixels of the image from which the CGH is generated in order to homogenize the light energy of the points of the projected image.

Typically, the values of the pixels of each image correspond to a colour index on a grey scale and they are translated into energy once the image is projected. This energy is approximately proportional to the value of each pixel.

The pixels of each image have a white (maximum value) or black colour (zero value), depending on whether they are to be projected or not. In order to eliminate the dependence on the number of points to be projected, according to the proposed method, the value of the black pixels is increased so that the energy contained therein compensates the excess energy in the white pixels.

According to an embodiment example, the method comprises carrying out said equalization step for each one of a plurality of images, depending on the maximum number of white pixels that are in the image of said plurality of images, that contains a greater number of white pixels, and on the number of white pixels and total number of pixels of the target image of the equalization step.

If the intention is to project, for example, several images with a grey scale of eight bits and with a maximum number of 460 white pixels and one of them contains only 100 white pixels, if no type of equalization were carried out then the energy in each one of the white pixels of this image would be 4.6 times greater than that of the white pixels of an image having the maximum of pixels. In order to equalize this image, the excess energy should be distributed among the black pixels, that is to say, to increase the value of the black pixels according to the following equation:

$$I = 255 ( \frac{m - n}{N - n} ) ,$$

where m is the maximum number of white pixels, n is the number of white pixels in the image to be equalized and N is the total number of pixels (white and black) in one image. In this way, the heterogeneity of the energy is also reduced by increasing the value of the black pixels; the more the value is increased the more homogeneous, but also lower, the energy will be, thus preventing the existence of large differences in the energy utilized to project, and where applicable to mark, the white points of different images, thus improving efficiency in the use of the irradiated laser energy.

Subsequent to said equalization step, the method comprises applying the step previously described that consists in compensation of the diffraction of each pixel.

FIG. 5 schematically illustrates the different steps carried out according to the sequence illustrated by the method proposed by the second aspect of the invention, said steps being carried out in a graphics processing unit (illustrated by means of dashed lines) of the proposed system, or another conventional system, in order to generate a CGH from a desired image.

With reference to said FIG. 5, and following the sequence from left to right, it is possible to observe the way in which the image is accessed by the graphics processing unit, where firstly the equalization described, indicated as EQ, is carried out, after which the compensation of the diffraction, indicated as CP, is carried out, then the IFTA is applied, and finally the “tiling” described previously, indicated in FIG. 5 as TL, is carried out, thus obtaining the CGH to which the Fresnel lens, indicated as FL, is added and the result of which is applied onto the SLM.

Those skilled in the art would be able to introduce changes and modifications to the described embodiment examples without departing from the scope of the invention defined by the enclosed claims.

1-16. (canceled)

17. A laser image projection system for marking an object with a desired optical image, the system comprising:
a reflection spatial light modulator;
laser beam irradiating means for irradiating laser light onto said reflection spatial light modulator at a certain incidence angle;
controlling means connected to said reflection spatial light modulator, said controlling means controlling said reflection spatial light modulator to define a holographic diffraction pattern corresponding to the desired optical image intended to be irradiated onto the object; and
focusing means for performing a Fourier transform of said phase-modulated laser light to transform it into said optical image and irradiate it focused onto said object, wherein said focusing means comprises a Fresnel lens holographically defined onto said reflection spatial light modulator to thereby improve an efficiency in the use of the light energy irradiated by said laser beam irradiating means.

18. A system according to claim 17, wherein said Fresnel lens is configured to cancel the effect of an undesired zero-order focus that part of said irradiated laser light could cause upon being reflected by the reflection spatial light modulator.

19. A system according to claim 18, wherein said focusing means only comprises said Fresnel lens which is configured to perform said Fourier transform.

20. A system according to claim 19, wherein said Fresnel lens is configured in order not to focus said zero-order focus but to focus said optical image properly onto said object.

21. A system according to claim 18, wherein said focusing means further comprises an optical system having at least one physical lens to perform said Fourier transform in cooperation with said Fresnel lens.

22. A system according to claim 21, wherein said Fresnel lens is arranged to shift the focal plane of said modulated laser light with respect to the zero-order or unmodulated laser light, so that the latter appears out of focus on said object and without enough energy to make a mark.

23. A system according to claim 18, wherein the marking of said object is the result of at least one single laser pulse.

24. A system according to claim 18, further comprising:
thermal conditioning means arranged on said reflection spatial light modulator to regulate the temperature thereon.

25. A system according to claim 24, wherein said thermal conditioning means further comprises:
a temperature sensor in contact with the reflection spatial light modulator,
a thermoelectric cell having a side built against the reflection spatial light modulator,
a heat sink built against the free side of said thermoelectric cell, and
a control system connected to said temperature sensor and to said thermoelectric cell to refrigerate or to heat the reflection spatial light modulator depending on the temperature variations detected by said temperature sensor.

26. A system according to claim 17, wherein said control means comprise a graphics processing unit to calculate said holographic diffraction pattern from some pixels of the desired optical image.

27. A method for marking an object in a laser image projection system, the image projection system having a reflection spatial light modulator, said method comprising:
irradiating laser light onto the reflection spatial light modulator;
defining a holographic diffraction pattern corresponding to the desired optical image intended to be irradiated onto the object; and
performing a Fourier transform of the phase-modulated laser light to transform it into said optical image and irradiating it focused onto the object, wherein the focusing means comprises a Fresnel lens holographically defined onto said reflection spatial light modulator.

28. A method according to claim 27, further comprising:
canceling the effect of an undesired zero-order focus that part of said irradiated laser light could cause upon being reflected by the reflection spatial light modulator.

29. A method according to claim 27, further comprising:
shifting a focal plane of the modulated laser light with respect to the zero-order or unmodulated laser light, so that the latter appears out of focus on said object and without enough energy to make a mark.

30. A method according to claim 27, wherein a marking of said object is the result of at least one single laser pulse.

31. A method according to claim 27, further comprising:
regulating the temperature on the reflection spatial light modulator.

32. A method for generating holograms to be applied in a reflection spatial light modulator of a laser image projection system for marking objects, comprising:
applying an iterative algorithm of Fourier transforms onto some pixels of a first image in order to calculate a hologram or holographic diffraction pattern to be defined onto said reflection spatial light modulator; and
prior to the application of said algorithm, equalizing said pixels of said image in order to homogenize the light energy of the points of the projected image to improve efficiency in the use of the light energy irradiated onto said reflection spatial light modulator.

33. A method according to claim 31, wherein said equalizing step for each one of a plurality of images depends on the maximum number of pixels that are to be projected onto each one of said plurality of images and on the number of pixels that are to be projected and on the total number of pixels of the target image of the equalizing step.

34. A method according to claim 31, further comprising:
applying said algorithm to the pixels of an image of smaller dimensions than the active surface of said reflection spatial light modulator, and
subsequent to the application of said algorithm, tiling the image or hologram obtained along an entire active surface of said reflection spatial light modulator, until covering it completely.

35. A method according to claim 31, further comprising:
subsequent to said equalizing step, performing a diffraction compensation of each pixel.

36. A method according to claim 31, wherein the system includes a Fresnel lens, the method further comprising:
holographically applying the Fresnel lens on the reflection spatial light modulator; and
adding the phase of the Fresnel lens to a final phase of said hologram or holographic diffraction pattern, defined on said reflection spatial light modulator.
